(19) United States
(12) Patent Application Publication
(10) Pub. No.: US 2013/0180140 A1
(43) Pub. Date: Jul. 18, 2013

(54) PACKAGING DISPLAY SYSTEM

(71) Applicants: Christopher MERRICK, Kent (GB); Ivan Mato FENTE, London (GB)

(72) Inventors: Christopher MERRICK, Kent (GB); Ivan Mato FENTE, London (GB)

(73) Assignee: NOKIA CORPORATION, Espoo (FI)

(21) Appl. No.: 13/351,120

(22) Filed: Jan. 16, 2012

(51) Int. Cl. G09F 7/00; B65D 25/34

(52) U.S. Cl. 40/584; 206/459.5

(57) ABSTRACT

A plurality of merchandise containers may include at least two adjacent sidewalls wherein at least two containers has a first predetermined image portion and a second predetermined image portion of a primary image. The sidewalls are disposed adjacent to each so that the first predetermined image portion and the second predetermined image portion collectively depict the primary image between at least two of the containers. The primary image may depict an article of manufacture. The primary image may depict a representative product to be retained or transported in the merchandise containers.

### FIELD

The disclosed subject matter generally relates to containers, in particular to a container and a system of containers for displaying a static image between a plurality of containers.

### BACKGROUND

In the shipping and packing industry, boxes are used for transporting products and materials to retailers or distributors. Merchandise storage containers can be used by retailers and customers in a retail environment.

### BRIEF SUMMARY

There is provided, in one aspect, a plurality of merchandise containers having at least two planar adjacent sidewalls wherein at least two containers has at least a first predetermined image portion and a second predetermined image portion of a primary image. The sidewalls are disposed adjacent to each so that the first predetermined image portion and the second predetermined image portion collectively depict the primary image between at least two of the containers.

In one aspect, the primary image depicts an article of manufacture. In yet another aspect, the article of the manufacture comprises a representative product to be retained in the merchandise containers.

In another aspect, the article of manufacture depicts an image of a mobile device. In another aspect, the first predetermined image portion and the second predetermined image portion comprise respectively, image portion depictions of a representative product to be retained in the merchandise containers. In yet another aspect, the first predetermined image portion and the second predetermined image portion comprise respectively, image portion depictions for an information brochure of a representative product to be retained in the merchandise containers.

In one aspect, one of the merchandise containers includes a first sidewall and a second sidewall connected to each other forming an exterior angle in which an exterior surface of the merchandise container depicts the primary image visually wrapped around the exterior angle from the first sidewall to the second sidewall creating a visual three dimensional optical effect of the primary image such that the first predetermined image portion is provided on the first sidewall and the second predetermined image portion is provided on the second sidewall.

There is provided, in one aspect, a merchandise container including a first sidewall and a second sidewall connected to each other forming an exterior angle in which an exterior surface of the merchandise container depicts a primary image visually extending around the exterior angle from the first sidewall to the second sidewall thereby creating a visual three dimensional depiction of the primary image; wherein the primary image depicts an article of the manufacture to be retained in the merchandise container.

### BRIEF DESCRIPTION OF THE DRAWINGS

The foregoing summary as well as the following detailed description, considered in conjunction with the accompanying drawings, provides a better understanding of the subject matter, in which like reference numbers refer to like elements, and wherein:

FIG. 1 is an exploded assembly view of a packaging system for forming an image;

FIG. 2 is a perspective view of the assembled packaging system;

FIGS. 3A-3D illustrated views of a container rotated to show the image configuration on different sides of the container; and

FIG. 4 is a front elevational view of a plurality of the containers from

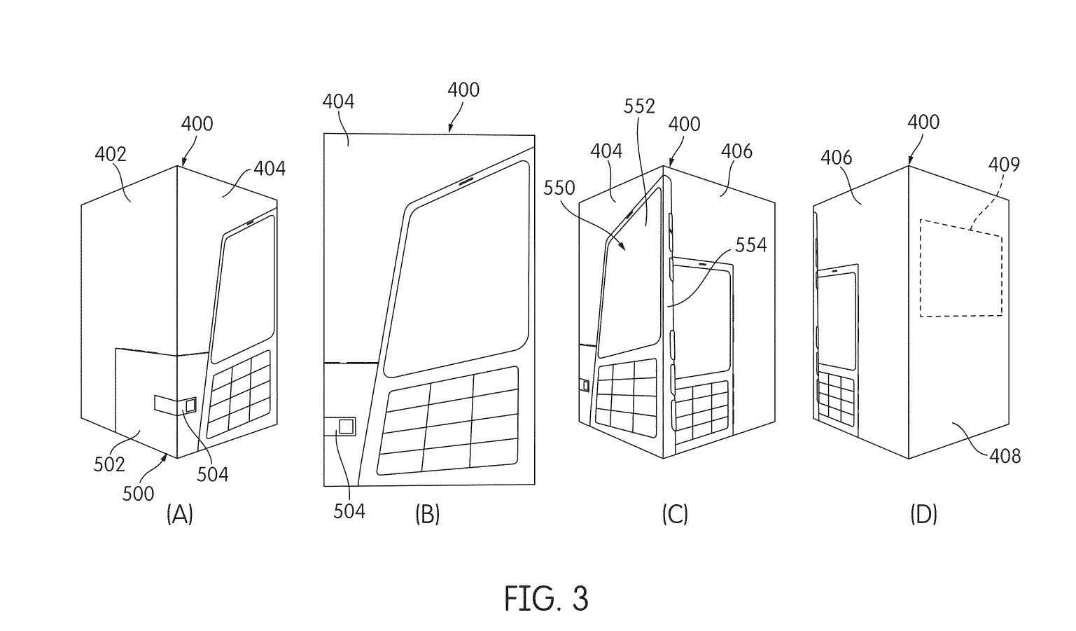

FIGS. 3A-D placed together to create a depiction of a continuous image display or information brochure.

### DETAILED DESCRIPTION

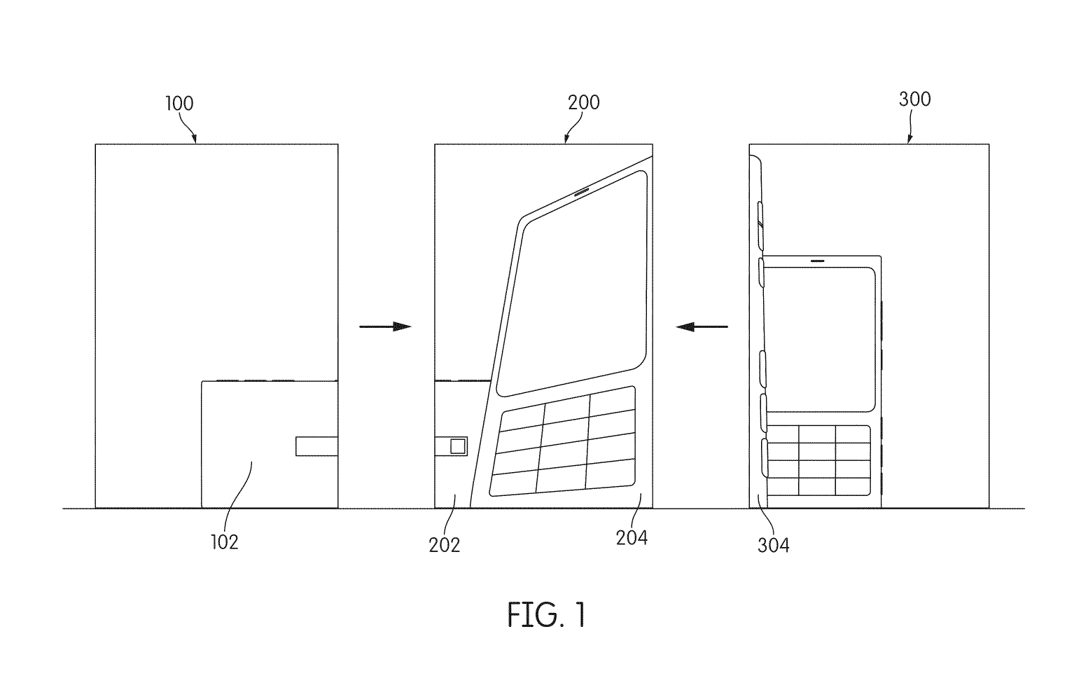

FIGS. 1-4 illustrate a packaging system and packages/containers for displaying at least one visual depiction of a predetermined image between adjacently disposed multiple packages or containers, such as merchandise containers. In FIG. 1, an exploded assembly view of a packaging system is shown. In the depicted construction of a merchandise container shown in FIG. 1, the vertical exterior surface of each container depicts different portions of a predetermined primary image pertaining to an article of manufacture, such as a mobile communications device. In this example arrangement, container 100 includes a left image portion 102 of a rear elevational view of a first mobile phone image 101 in a horizontal orientation. Container 200 includes a right image portion 202 of the same rear elevational view of the first mobile phone image and a first partial perspective front image 204 of a second mobile phone image 201. Likewise, container 300 includes a second partial perspective front image 304 of the second mobile phone image.

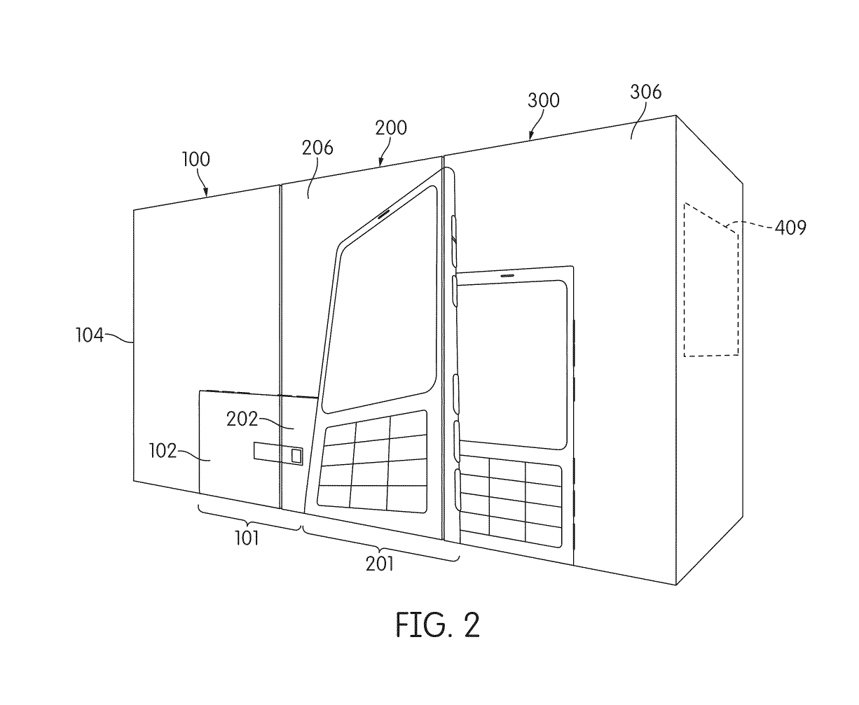

FIG. 2 illustrates a perspective view of the assembled packaging system including containers 100, 200, and 300 for displaying images. In the assembled configuration, the rear elevational view of the first mobile phone image is a side-by-side combination of the left image portion 102 and the right portion image 202. It is noted that two containers 100 and 200 are disposed adjacently to bring to the left image portion 102 and right portion image 202 together to collectively depict the rear elevational view of the first mobile phone image 101. The perspective view of the second mobile phone image 201 is a side-by-side combination of the first partial perspective front image 204 and a second partial perspective front image 304. For example, the system could be employed in a retail environment or in a point of sales display for presenting a continuous information brochure using a plurality of containers. The sidewalls 104, 206, 306 of the containers 100, 200, 300, respectively, are planar to best display the visual depiction of the images on the exterior surfaces.

FIGS. 3A-3D illustrates views of a merchandise container 400 rotated to show predetermined images extending from one sidewall of a container to an adjacent sidewall of the same container. The container 400 includes four vertical exterior sidewalls 402, 404, 406, 408 and top and bottom panels. In the depiction of container 400 shown in FIGS. 3A and 3B, the exterior surface of container depicts an image element 500 visually wrapped around or extending to the vertical sidewalls 402, 404 such that at least two sidewalls of the container includes an image portion 502, 504 of a primary image 500. In this example arrangement, the primary image is a distinct visual element separate from a background on the container. The primary image can be an appropriate image that is the subject of the merchandise container. In this example, the primary image pertains to a communication device, such as a mobile phone. Nevertheless, the primary image can be other objects or relate to an article of manufacture.

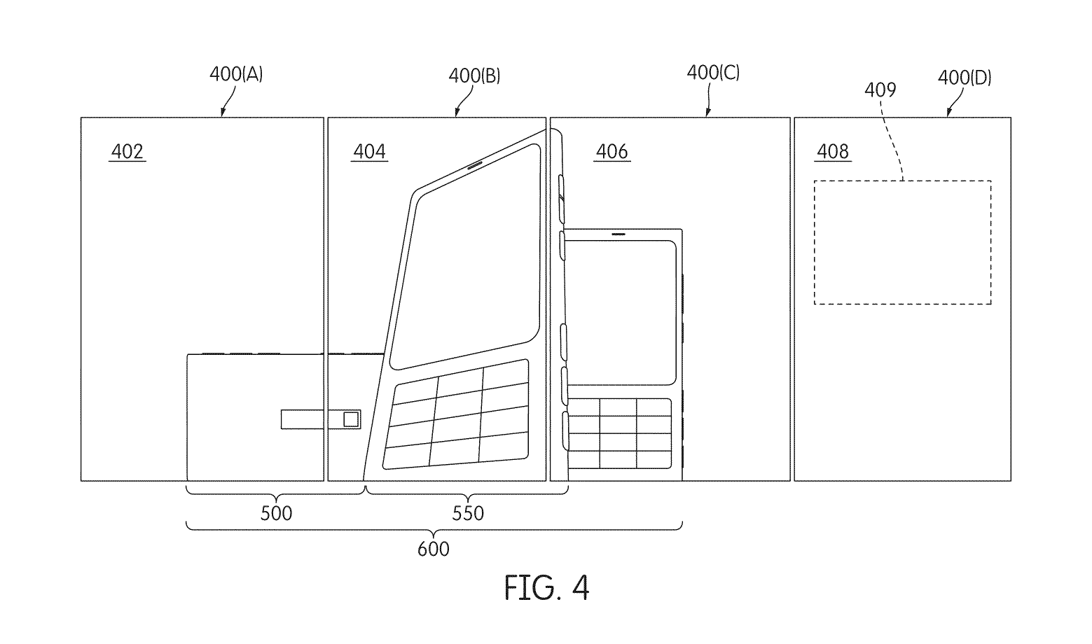

As shown in FIG. 4, when two containers 400A, 400B having the same image are placed in an abutting side-by-side relationship to align the images portions 502, 504 of the primary image 500 thereon, the image portions 502, 504 on each container collectively create a visual depiction of the primary image 500. In this way, a plurality of containers creates a static display system for at least one image across multiple sidewalls of containers.

The cube shaped container includes four vertical exterior sidewalls 402, 404, 406, 408 and top and bottom panels. In the depicted construction, the four vertical sidewalls 402, 404, 406, 408 serve as display panels for the information brochure 600 including at least one image to be displayed among the sidewalls of containers 400A, 400B, 400C. As shown in FIG. 4, the information brochure may include a continuous image extending across more than two containers (400A, 400B, 400C). If desired, the information brochure may include images as well as text 409 as shown on sidewall 408 (container 400D). The system may include a plurality of containers or packages 400A-400C in which the depiction of a first element 502 on a front surface of a first package 400A is continued on an exterior surface of a second package 400B thereby defining a second element 504, such that a combination of the depiction of the first element 502 and second element 504 visual collectively depict the first element 500. This noted visual depiction occurs when the edges of the faces/surfaces 402, 404 of the first package 400A and the second package 400B are placed in an adjacent abutting relationship.

In the depicted construction, the cube shaped container or rectangular shaped container can be constructed of a paperboard material or other material, such as plastic. The container can be constructed to hold and transport any appropriate device or product, such as a mobile communication device, for example. Nevertheless, the container can have a width height, and depth appropriate for retaining an object therein for transportation and use by the consumer or other individual. The image or images printed on the sidewalls of the container can be placed on the paperboard using conventional printing techniques. In accordance with concepts herein, the container shapes may be polyhedral such that at least two adjacent sidewalls can be place side-by-side to display an image composed of image portions on the sidewalls.

In one configuration as shown FIGS. 1-4, the image on the container is a depiction of the device or product to be transported or retained in the merchandise container. This type of configuration provides a visual cue to the consumer so as to the contents of the container to provide an enhanced retailing experience. Additionally, this configuration obviates the apparent need for the individual purchasers from opening a retail box to view the product inside. In this manner, waste at the point of sale is reduced thereby saving costs and providing improved efficiencies.

In one configuration as shown FIGS. 1-4, there is created a three dimensional optical illusion as a result of placing the image of the article of manufacture itself wrapping around the edge of the container. The viewer perceives the three dimensionality configuration of the article of manufacture and the shape. For example, in the depiction of container 400 shown in FIG. 3A, the exterior surface of container depicts an image element 500 visually wrapped around or extending to the vertical sidewalls 402, 404 such that at least two sidewalls of the container includes an image portion 502, 504 of a primary image 500. In another an example, in the depiction of container 400 shown in FIG. 3C, two sidewalls 404, 406 connected to each other forming an exterior angle in which the exterior surface of container 400 depicts an image element 550 visually wrapped around or extending to the vertical sidewalls 404, 406 such that at least two sidewalls of the container includes an image portion 552, 554 of a primary image 550. A three dimensional optical illusion as a result of placing the image 400 or 550 of the article of manufacture itself wrapping around the edge of the container.

Thus, a packaging system for displaying a static image on a plurality of packages and package has been described. While the subject system and package has been described with reference to exemplary configurations, it will be understood by those of ordinary skill in the art that various changes may be made and equivalents may be substituted for elements thereof without departing from the scope. In addition, many modifications may be made to adapt a particular situation or material to the teachings of the described herein without departing from the scope thereof. Therefore, it is intended that the subject disclosure not be limited to the particular configurations and arrangements disclosed, but that the concepts will include all embodiments falling within the scope of the appended claims.

What is claimed is:

1. A system, comprising:
a plurality of merchandise containers having at least two planar adjacent sidewalls; wherein at least two of the merchandise containers includes at least a first predetermined image portion and a second predetermined image portion of a primary image; wherein the sidewalls are disposed adjacent to each so that the first predetermined image portion and the second predetermined image portion collectively depict the primary image.

2. The system of claim 1, wherein the primary image depicts an article of manufacture.

3. The system of claim 2, wherein the article of the manufacture comprises a representative product to be retained in the merchandise containers.

4. The system of claim 3, wherein the article of manufacture depicts a mobile device.

5. The system of claim 2, wherein the article of manufacture depicts a mobile device.

6. The system of claim 1, wherein the first predetermined image portion and the second predetermined image portion comprise collectively, image depictions of a representative product to be retained in the merchandise containers.

7. The system of claim 1, wherein the first predetermined image portion and the second predetermined image portion comprise respectively, image portion depictions for an information brochure of a representative product to be retained in the merchandise containers.

8. The system of claim 1, wherein the primary image depicts a mobile communication device.

9. The system of claim 1, wherein the primary image further comprises an article of the manufacture to be retained in the merchandise containers and the primary image pertains to an orientation for retail display.

10. The system of claim 1, wherein at least one the merchandise containers includes a first sidewall and a second sidewall connected to each other forming an exterior angle in which an exterior surface of the merchandise container depicts the primary image visually wrapped around the exterior angle from the first sidewall to the second sidewall creating a visual three dimensional optical effect of the primary image; wherein the first predetermined image portion is provided on the first sidewall and the second predetermined image portion is provided on the second sidewall.

11. The system of claim 10, wherein the primary image depicts an article of manufacture.

12. The system of claim 10, wherein the primary image depicts an article of manufacture to be transported in the merchandise container.

13. A merchandise container, comprising:
a first sidewall and a second sidewall connected to each other forming an exterior angle in which an exterior surface of the merchandise container depicts a primary image visually extending around the exterior angle from the first sidewall to the second sidewall thereby creating a visual three dimensional depiction of the primary image; wherein the primary image depicts an article of the manufacture to be retained in the merchandise container.

14. The merchandise container of claim 13, wherein the primary image depicts an electronic device.

15. The merchandise container of claim 13, wherein the primary image depicts a mobile communication device.

16. The merchandise container of claim 13, wherein the container comprises paperboard.
